(19) United States
(12) Patent Application Publication
(10) Pub. No.: US 2006/0243817 A1
(43) Pub. Date: Nov. 2, 2006

(54) VISCOUS FAN DRIVE WITH A FLUID CONTROL VALVE

(75) Inventors: GERARD M. LIGHT, MARSHALL, MI (US); JAMES P. MAY, JACKSON, MI (US); CLINTON J. GAUTSCHE, UNION CITY, MI (US)

Correspondence Address: BORGWARNER INC., 3850 HAMLIN ROAD, AUBURN HILLS, MI, 48326-2872, US

(73) Assignee: BorgWarner Inc., Auburn Hills, MI (US)

(21) Appl. No.: 11/277,533

(22) Filed: Mar. 27, 2006

Related U.S. Application Data
(60) Provisional application No. 60/676,875, filed on May 2, 2005.

(51) Int. Cl. F24J 3/00; B60H 1/00; B60H 1/03

(52) U.S. Cl. 237/12.3 R

(57) ABSTRACT

An improved valve disk having a modified cylinder region that includes a first arc section and a second arc section separated by a pair of non-arced sections. These arc sections are positioned to correspond to fill holes in an electronically controlled viscous coupling system. The arc sections have sufficient length and height to seal over the fill holes when the viscous coupling is in a disengaged position. The arc sections each have a face/end portion that each seal to the reservoir cover when the viscous coupling is in the disengaged position. To ensure proper location of the arc sections relative to the fill holes, the valve disk is pinned or otherwise coupled to the input coupling assembly in a way that prevents rotational movement of the valve disk.

### CROSS REFERENCE TO RELATED APPLICATION

The present invention claims priority from U.S. Provisional Application Ser. No. 60/676,875 filed May 2, 2005. The present invention is related to U.S. Pat. No. 6,752,251, filed on Nov. 4, 2002, and to U.S. patent application Ser. No. 11/170,828, filed on Jun. 30, 2005, which are incorporated by reference herein.

### TECHNICAL FIELD

The invention relates generally to fan drive systems and more specifically to a viscous fan drive having a modified and improved valve disk.

### BACKGROUND ART

The present invention relates to fluid-coupling devices of the type including both fluid operating chamber and a fluid reservoir chamber, and specifically to the valving which controls the quantity of fluid in the operating chamber.

Although the present invention may be used advantageously in fluid-coupling devices having various configurations and applications, it is especially advantageous in a coupling device of the type used to drive a radiator cooling fan of an internal combustion engine, and will be described in connection therewith.

Fluid-coupling devices (“fan drives”) of the viscous shear type have been popular for many years for driving engine cooling fans, primarily because their use results in substantial saving of engine horsepower. The typical fluid-coupling device operates in the engaged, relatively higher speed condition only when cooling is needed, and operates in a disengaged, relatively lower speed condition when little or no cooling is required. These devices typically use fluid control valves to control the amount of viscous fluid entering or exiting the working chamber to control the relative engagement of the fan drive at a given input speed.

Electronically controlled fluid-coupling devices utilize a valve disk to control the amount of viscous fluid entering the working chamber through a fill hole. Valve positioning is controlled by a magnetic solenoid, which moves the valve disk to cover or uncover the fill hole based on a comparison of the current engine operating conditions and the desired engine operating conditions. If additional engine cooling is desired at a particular engine operating speed, the solenoid produces a magnetic field to move the valve disk to uncover the fill hole, therein allowing viscous fluid to enter the working chamber of the fluid coupling to engage the output and drive a coupled fan.

Currently available valve disks suffer from many problems associated with their current design. Most problematic among current designs is that the outer cylinder used to seal and unseal the fill holes requires tight control of the size and roundness on the entire cylinder periphery. Too much clearance between the valve and the inner surface of the input coupling and the valve leaks. Too little clearance and the valve sticks. Moreover, the sealing of the face/end region of the valve to the reservoir cover requires tight control of the flatness and perpendicularity over its entire surface.

Another issue with the present design is particle contamination. Any little speck of material that gets lodged between the valve and the input coupling will cause sticking of the valve. Any speck of material between the face/end and the reservoir cover will cause a fluid leakage path.

Yet another issue with the current valve disks is associated with valve positioning as controlled by the magnetic solenoid. Anything that will reduce the force to move the valve, and lessens the so-called “stiction” effect that occurs along the axial sealing surface, is ideal. Further, any changes to the surface of the valve and associated surface in the coupling that will decrease fluid drag is also highly desired.

### SUMMARY OF THE INVENTION

The present invention addresses some of the issues described above by providing a strategy for removing a portion of the outer cylinder portion of the valve that is not associated with controlling the movement of viscous fluid from the fluid reservoir chamber to the fluid working chamber through the fill hole.

To accomplish this, an improved valve disk is depicted having a modified cylinder region in which two regions of the outer-arced surface spaced one hundred eighty degrees apart relative to each other are removed, leaving a first arc section and a second arc section separated by a pair of non-arced sections. These arc sections are positioned to correspond to the fill holes and have sufficient length and height to seal over the fill holes when the valve is in the disengaged position. The arc sections each have a face/end portion that each seal to the reservoir cover when the viscous coupling is in the disengaged position.

To ensure proper location of the arc sections relative to the fill holes when the viscous coupling is disengaged, the valve disk is pinned or otherwise coupled to the input coupling assembly in a way that prevents rotational movement of the valve disk. This can be accomplished by utilizing projections contained within a portion of the valve disk that are contained within openings in the input coupling assembly, or alternatively by utilizing projections within the input coupling assembly that are contained within corresponding openings of the valve disk.

Other features, benefits and advantages of the present invention will become apparent from the following description of the invention, when viewed in accordance with the attached drawings and appended claims.

### BRIEF DESCRIPTION OF THE DRAWINGS

FIG. 1 is a perspective view of a fluid-coupling device according to the Prior Art;

FIG. 2 is a section view of FIG. 1 taken along line 2-2 showing the fluid-coupling device in a disengaged position;

FIG. 3 is a section view of FIG. 1 taken along line 2-2 showing the fluid-coupling device in a fully engaged position;

FIG. 4 is a perspective view of the one side of the clutch of FIG. 1;

FIG. 5 is a perspective view of one side of the cover member and wiper of FIG. 1;

FIG. 6 is a perspective view of the valve disk of FIGS. 1-3;

FIG. 7 is a perspective view of a valve disk according to a preferred embodiment of the present invention;

FIG. 8 is a section view of a portion of a viscous fan drive incorporating the valve disk of FIG. 7;

FIG. 9 is a perspective view of a valve disk according to a preferred embodiment of the present invention;

FIG. 10 is a section view of a portion of a viscous fan drive incorporating the valve disk of FIG. 9;

FIG. 11 is a perspective view of a valve disk according to a preferred embodiment of the present invention; and

FIG. 12 is a section view of a portion of a viscous fan drive incorporating the valve disk of FIG. 11.

### BEST MODE(S) FOR CARRYING OUT THE INVENTION

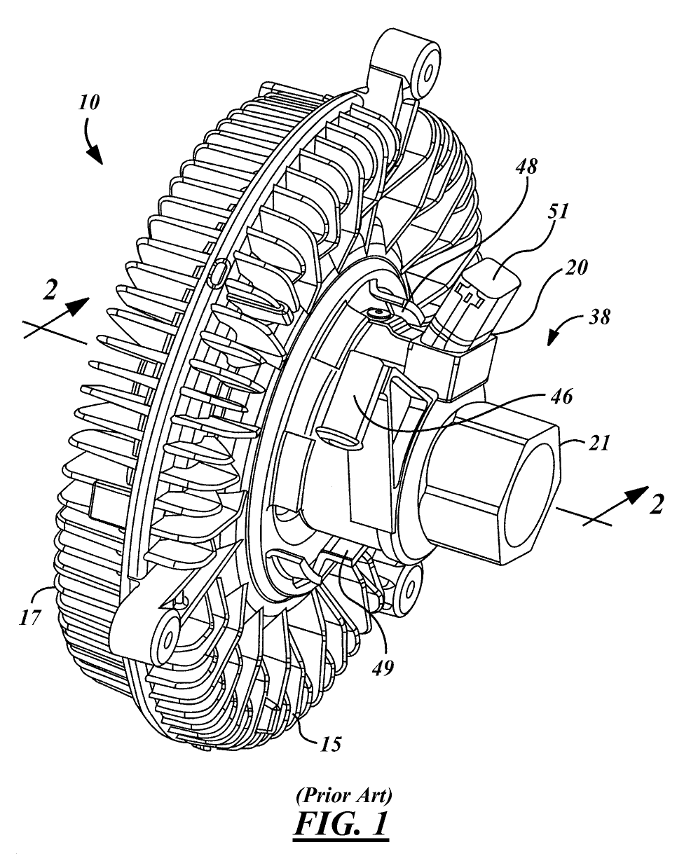

Referring now to the drawings, which are not intended to limit the invention, FIGS. 1-6 illustrates one form of a fluid-coupling device 10 (“viscous fan drive”) of a type in accordance with the prior art and is described substantially in U.S. patent application Ser. No. 11/170,828, filed on Jun. 30, 2005, and entitled “Electronically Controlled Viscous Fan Drive Having Cast Channels”, which is incorporated by reference herein. The fluid-coupling device 10 includes an input-coupling member, or clutch, generally designated 11, and an output-coupling member, or assembly, generally designated 13. The assembly 13 includes a housing member (body) 15, and a cover member (enclosure) 17, the members 15 and 17 being secured together by a rollover of the outer periphery of the cover member 17, as is well known in the art.

The fluid-coupling device 10 is adapted to be driven by a liquid cooled engine, and in turn, drives a radiator-cooling fan, neither of which is shown herein. The fan may be attached to the housing member 15 by any suitable means, such as is generally well known in the art, and as is illustrated in the above-incorporated patents. It should be understood, however, that the use of the present invention is not limited to any particular configuration of fluid-coupling device, or fan mounting arrangement, or any particular application for the fan drive, except as is specifically noted hereinafter. For example, the present invention could be used with a fan drive of the type adapted to have the radiator-cooling fan attached to the cover member, rather than to the body member.

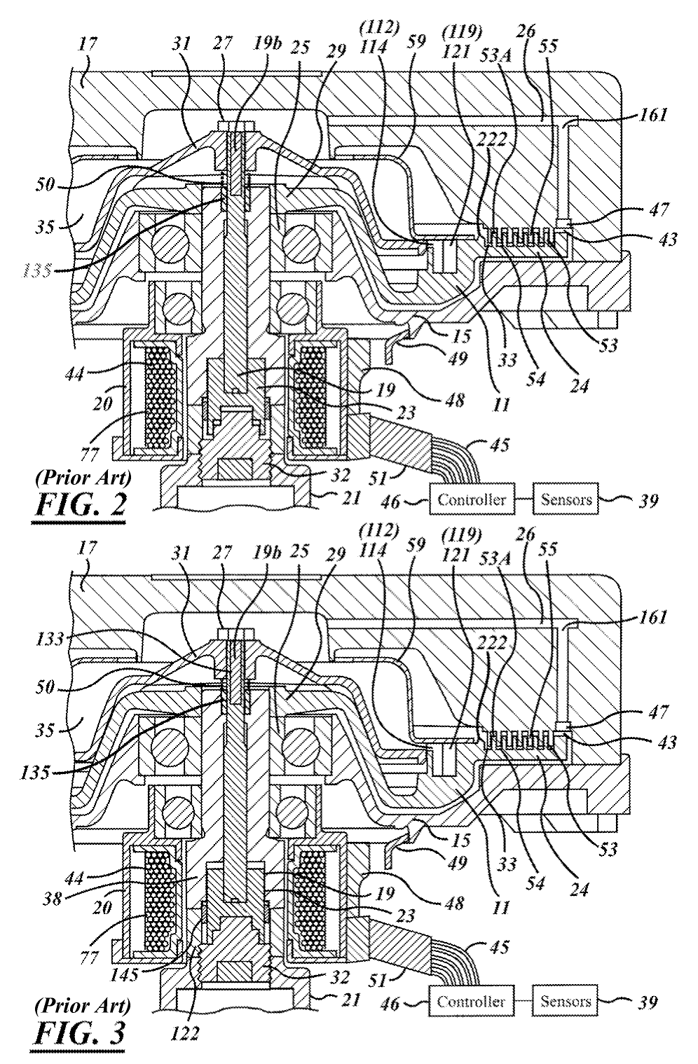

As best shown in FIGS. 2 and 3, the coupling device 10 includes an input-coupling assembly 38 on which the input-coupling member 11, or clutch, is mounted. The input-coupling assembly 38 is rotatably driven, such as by means of an hexagonal, internally threaded portion 21, which would typically be threaded onto an externally threaded shaft extending from the engine water pump. The assembly 38 functions as a support for the inner race of a bearing set 25, which is seated on the inside diameter of the housing member 15. The input coupling assembly 38 is also coupled to and surrounds an actuator shaft 19. The forward end 19b of an actuator shaft 19 is slidingly engaged between the assembly 38 and an opening defined by a hub portion 29 of the input-coupling member 11. As a result, rotation of the assembly 38 causes rotation of the input-coupling member 11. An armature 23 is also coupled to a portion of the actuator shaft 19, which is kept in place within the assembly 38 by a plug 32. The armature 23 is guided within the assembly using a close fitting bushing 145.

The housing member 15 and the cover member 17 cooperate to define a fluid chamber, which is separated by means of a substantially circular valve disk 31 and reservoir cover 59, into a fluid operating chamber 33 and a fluid reservoir chamber 35. The valve disk 31 is operatively coupled with the forward end 19b of the actuator shaft 19 by screw 27 and is disposed within the reservoir cover 59 and the input-coupling member 11. The cover member 17 and the input-coupling member 11 define the fluid operating chamber 33, while the reservoir cover 59 and the input-coupling member 11 define the fluid reservoir 35.

The input-coupling member 11 includes a plurality of annular lands 53 that are located outwardly from the hub 29. The adjacent surface of the cover member 17 includes a plurality of corresponding annular lands 55. The annular lands 53, 55 are interdigitated to define a serpentine-shaped viscous shear space 54 therebetween. It is believed that in view of the above-incorporated U.S. Patent and Application, those skilled in the art can fully understand the construction and operation of the fluid-coupling device illustrated in FIGS. 1-5, as well as the various flow paths for the viscous fluid.

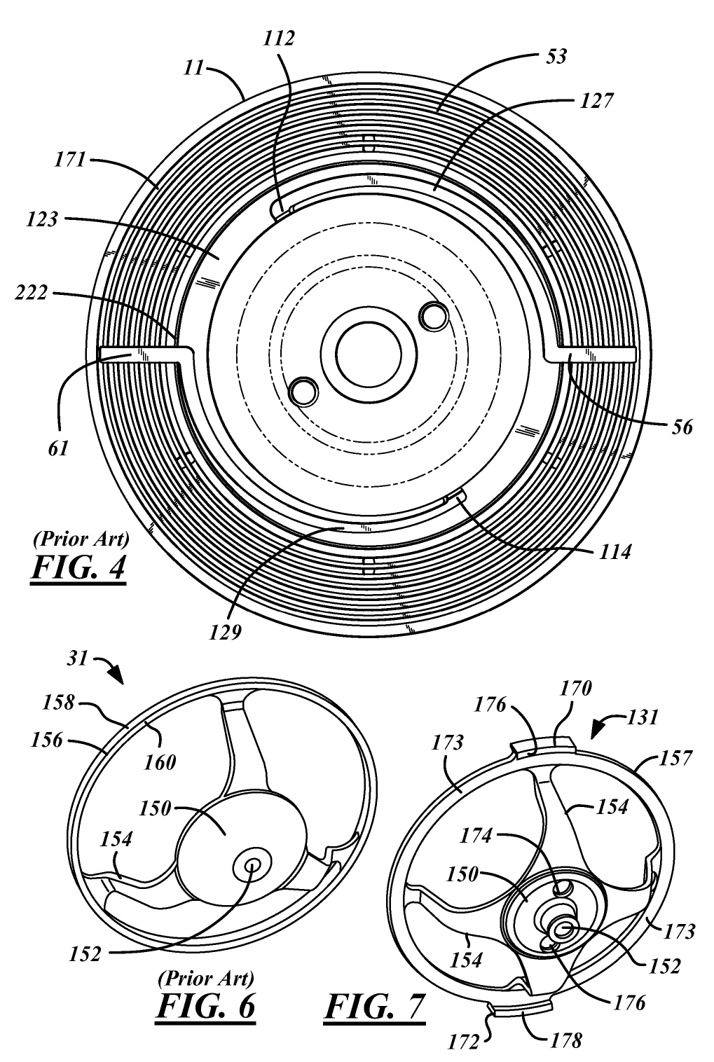

As best seen in FIGS. 4 and 5, the input coupling member 11 and cover member 17 also each include a pair of radial slots 56, 61 and 81, 83 that are used on the input-coupling member 11 and cover 17 to help get viscous fluid in and out of the viscous shear space 54 of the operating chamber 33.

The input-coupling member 11 also included a pair of cold pump out slots 127, 129 defined between the rollover 222, and a sealing surface 123. The reservoir cover 59 seals onto the top of the sealing surface 123 held in place by the rollover 222 (shown before the rollover operation). The slots 127 and 129 and reservoir cover 59 therefore define a passageways 119 and 121, respectively. The passageways 119, 121, being oriented 180 degrees opposite each other around the outer periphery of the clutch 11 act as an antidrainback chamber when the fan drive is not rotating therein minimizing morning sickness that typically occurs in viscous type clutch systems.

The cover 59 and input coupling member 11 also define a pair of fill holes 112, 114. The fill holes 112, 114 are preferably disposed 180 degrees opposite each other around the periphery of the input-coupling member 11 with respect to one another and are located at the junction between the reservoir chamber 35 and the respective passageways 119, 121. As will be described in further detail below, the fill holes 112, 114 may be opened or covered (i.e. closed), depending upon the relative positioning of the valve disk 31 relative to the fill holes 112, 114, to control the amount of viscous fluid entering the operating chamber 33 and shear space 54 through the slots 119, 121. Varying the amount of viscous fluid within the shear space 54 varies the wetted area of the shear space 54 and thereby controls the amount of torque transferred from the input coupling member 11 to the cover member 17 at a given engine input speed. The cover member 17 also includes a pumping element 47, also referred to as a “wiper” element, operable to engage the relatively rotating fluid in the shear space 54, and generate a localized region, or scavenge area 43 of relatively higher fluid pressure. As a result, the pumping element 47 continually pumps a small quantity of viscous fluid from the shear space 54 back into the reservoir chamber 35 through a scavenge hole 161 coupled to a radial passage 26 defined by the cover member 17 at a given engine input speed, in a manner well known in the art.

Referring now to FIGS. 2-3, the actuator subassembly 20 includes a plurality of coils 77 contained within a bobbin 44. The coils 77 are electrically coupled to an external controller 46 through wires 45 contained within an electrical connector 51 coupled to the bobbin 44. The external controller 46 is also electrically coupled to a Hall effect sensor 48 through connector 51. The Hall effect sensor 48 senses the rotational speed of the housing member 15 via one or more pole pieces 49 coupled to the housing member 15 and sends an electrical impulse to the controller 46 as a function of the measured rotational speed. A plurality of other sensors 39, including, for example, an engine temperature sensor, are also electrically connected to the controller 46 and provide electrical signals regarding a particular engine operating parameter.

The controller 46 interprets the electrical signals from the Hall effect sensor 48 and other sensors 39 and sends an electrical signal to the coils 77 to control the relative positioning of the valve disk 31 to control the relative engagement or disengagement of the output coupling member 13.

As may be best seen in FIG. 2, when the coupling device 11 is rotating and in the disengaged position, a spring 50 biases the valve disk 31 to cover the fill holes 112, 114, and hence substantially all of the viscous fluid in the device 10 is contained within the fluid reservoir chamber 35. The spring 50, as shown in FIGS. 2 and 3, is coupled along the outer periphery of the actuator shaft 19 and between the valve disk 31 and the adjacent end of input coupling assembly 38. In the disengaged position, viscous fluid is prevented by the valve disk 31 from entering the operating chamber 33 and shear space 54 to drive cover member 17. In FIG. 3, when the coupling device 11 is rotating and in the fully engaged position, viscous fluid flows freely through the respective fill hole 112, 114 to the operating chamber 33 to drive the cover member 17 and coupled fan as a function of the given input speed and amount of viscous fluid contained in the shear space 54. Each is described in further detail below.

To engage the fan drive, as shown in FIG. 3, the external controller 46 sends an electrical signal through the actuator subassembly 20 to the electrical coil 77, therein creating a magnetic flux through the input-coupling assembly 38 within the viscous fan drive 10, including the armature shaft 19, armature 23 and plug 32, but not through a non-magnetic metal wafer portion 122 welded to a portion of the assembly 38. The armature 23, which is common steel, reacts in response to the magnetic flux to axial move in a direction away from the spring 50 (i.e. moving in a direction against the spring 50 (downward in FIG. 3)) within the assembly 38 and along the bushing 145. As the actuator shaft 19 and valve disk 31 are coupled to the armature 23, they are pulled downward as well, thereby causing valve disk 31 to unseal from the reservoir cover 59 and uncover the cast-in fill holes 112, 114, thereby allowing the movement of viscous fluid from the reservoir chamber 35 to the operating chamber 33 through the respective slots 119, 121 and through slots 56, 61. This viscous fluid then enters the shear space 54. As the fluid fills the shear space 54 it transmits torque from the input coupling member 11 to the cover member 17 as it is sheared, thereby driving the cover member 17 (and hence the output coupling member 13 including a fan remotely coupled to the cover member 17) as a function of the input speed to the input-coupling member 11 and as a function of the amount of viscous fluid contained in the shear space 54, as is understood by those of ordinary skill in the art. This is the so-called engaged position, as shown in FIG. 3.

By decreasing the amount of power to the actuator subassembly 20, and hence magnetic flux available to pull the armature 23 downward, the spring 50 biases back towards its natural position (back toward the position as shown in FIG. 3), thereby urging the valve disk 31 back towards the reservoir cover 59 to partially cover the fill hole 112, 114. This allows viscous fluid to enter the operating chamber 33 through the fill hole 112, 114, but at a rate less than the fully engaged position. This is the so-called mid-range or partially engaged position. In this position, the cover member 17 and output coupling member 13 rotates at a rate slower than the fully engaged position as a function of the relatively lesser amount of viscous fluid entering the shear space 54.

In the absence of electrical actuation, as shown in FIG. 2, the spring 50 biases back to its natural position and therein urges the valve disk 31 upwardly to seal against the reservoir cover 59 and cover the fill hole 112, 114. This prevents viscous fluid from entering the operating chamber 54, and therein prevents the viscous engagement of the cover member 17 and output coupling member 13 as a result.

The amount of electrical power supplied in terms of pulse width modulation from the external controller 46 and power source, and hence the amount of magnetic flux created to drive the armature 23 therefore in response, is determined by the external controller 46. The controller receives a set of electrical inputs from various engine sensors 38, and Hall effect sensor 48. When the controller 46 determines that one or more of these sensors is sensing an engine operating conditions outside the desired range, the external controller 46 and power source will send electrical signal to the coil 77. Thus, for example, if the external controller 46 determines that the engine coolant temperature is too high as measured by sensor 39, a signal may be sent from the controller 46 to the actuator subassembly 20 to activate the coil 77 to a desired pulse width, therein pulling the armature 23 to partially or fully uncover the valve disk 31 from fill holes 112, 114.

Of course, as one of skill in the art appreciates, the actual amount of pulse width modulation necessary to move the valve 31 between a fully engaged and disengaged position is dependent upon many factors. For example, the size and shape of the spring 50 itself is a major factor is the amount of pulse width modulation necessary to move the armature 23. A stiffer or larger spring 50 may require a larger pulse width to achieve a similar biasing of the spring 50 as compared with a more flexible or smaller spring.

Further, the size of the fill holes 112, 114 may affect the amount of biasing necessary. For example, clutch 11 with larger fill holes 112, 114 may only require the valve disk 31 to slightly uncover one or both of the fill holes 112, 114 in order to provide adequate viscous fluid flow to the operating chamber 33 and shear space 54.

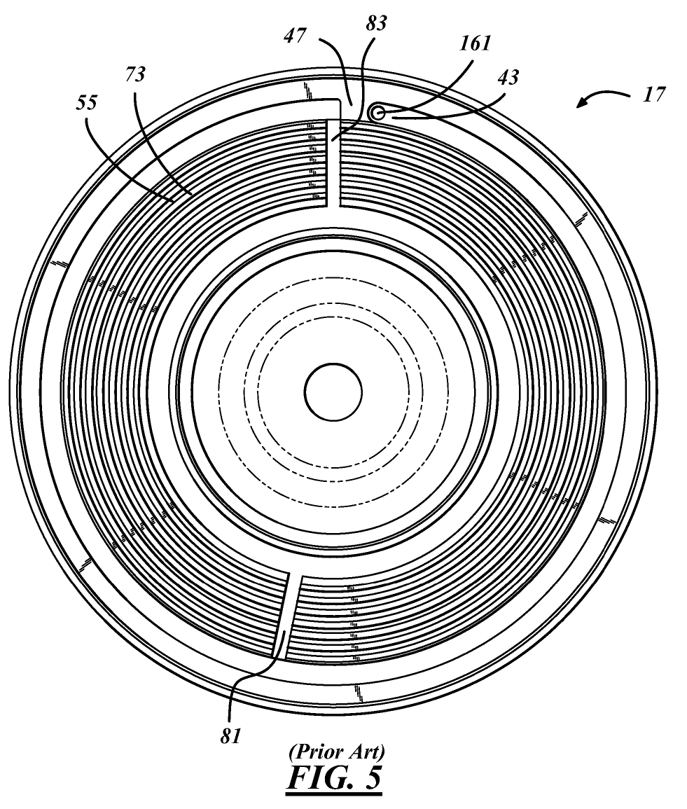

Referring now to FIGS. 6-12, a perspective view of the valve disk, in accordance with the prior art (shown as 31 in FIG. 6) and in accordance with three preferred embodiments of the present invention (shown as 131 in FIGS. 7-12), is depicted. The improved valve disk 131 replaces the valve disk 31 in the viscous fan drive 10 as shown in FIGS. 1-3 and functions in exactly the same way as the valve disk 31, but with improvements as detailed below.

Referring first to FIG. 6, the valve disk 31 in accordance with the prior art includes a central hub region 150 having an opening 152. As best seen in FIGS. 2 and 3, a screw 27 is inserted through opening 152 to couple the valve disk 31 to actuator shaft 19.

The valve disk 31 also includes a plurality of arms 154 extending outwardly from the central hub region 150 to a cylinder region 156. The number of arms 154 is important only to the extent that the valve disk is radially balanced relative to an axis extending through the center of the actuator shaft 19 and opening 152. Thus, if two arms 154 are utilized, they extend radially outward 180 degrees apart relative to one another about an axis defined by the actuator shaft 19 and opening 152. Similarly, if three arms 154 are utilized, they extend radially outward 120 degrees apart relative to one another about an axis defined by the actuator shaft 19 and opening 152.

The cylinder region 156 includes a continuous outer-arced surface 158 and a perpendicular face/end surface 160. The continuous outer-arced surface 158 is slidingly engaged to an inner surface 162 of the input coupling assembly 11 that is substantially parallel to the actuator shaft 19. The outer-arced surface 158 also seals over the respective fill holes 112, 114 when the disengaged position as shown in FIG. 2. The perpendicular face/end surface 160 seals against the reservoir cover 59 when the valve 31 is in the disengaged position.

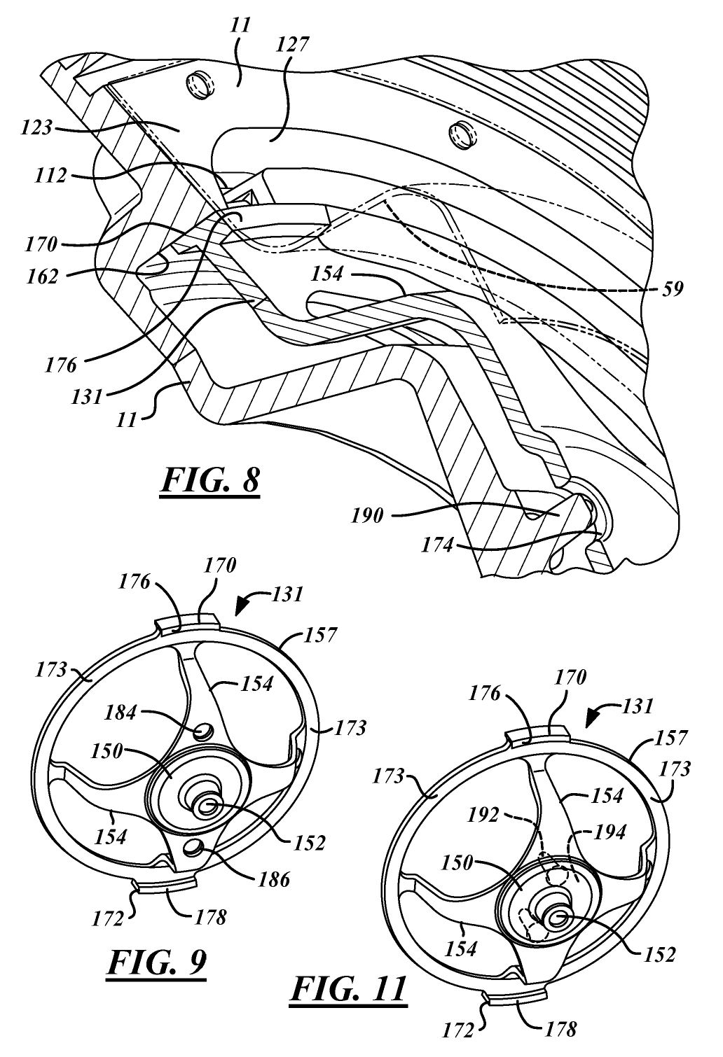

Referring now to FIGS. 7 and 8, an improved valve disk 131 according to one preferred embodiment is depicted having a modified cylinder region 157. As shown best in FIG. 7, two regions of the outer-arced surface spaced one hundred eighty degrees apart relative to each other are removed, leaving a first arc section 170 and a second arc section 172 separated by a pair of non-arced sections 173. As best shown in FIG. 8, these arc sections 170, 172 are positioned to correspond to the fill holes 112, 114 and have sufficient length and height to seal over the fill holes 112, 114 when the valve 131 is in the disengaged position. The arc sections 170, 172 each have a face/end portion 176, 178 that each seal to the reservoir cover 59 similar to the face/end surface 160 of valve 31.

To ensure proper location of the arc sections 170, 172, the central hub region 150 is formed with two additional openings 174, 176, wherein the valve disk 131 is pinned or otherwise coupled around projections 190 in the input coupling assembly 11. Of course, potential alternative embodiments for aligning the valve disk 131 are specifically contemplated. For example, the number of openings used to align the valve disk 131 may be three, four or more.

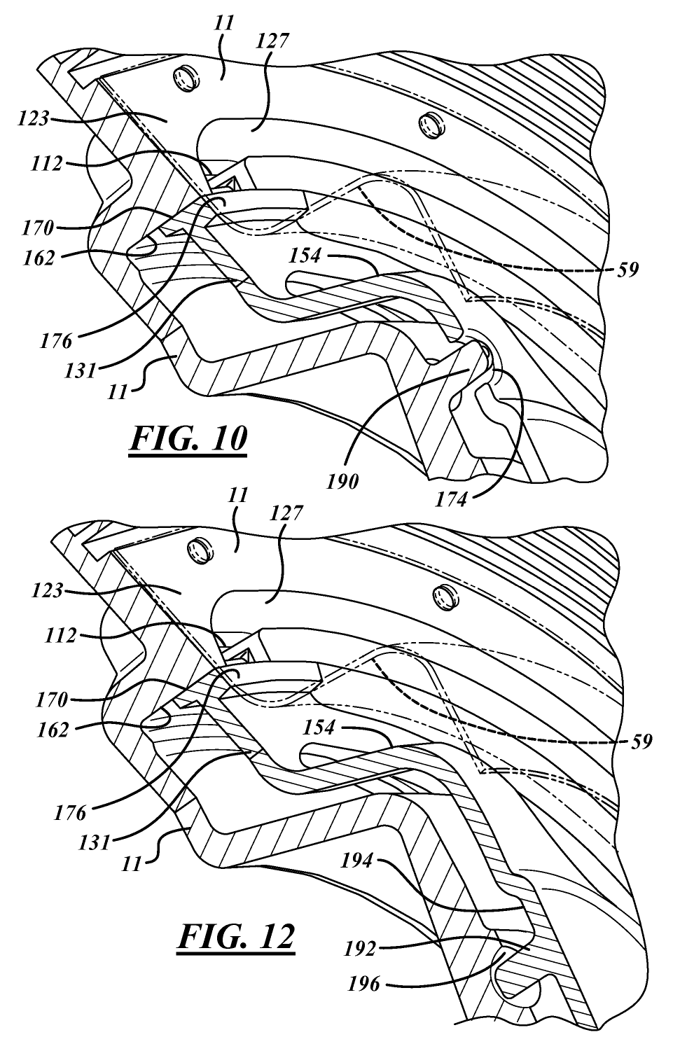

Moreover, as best shown in FIGS. 9 and 10 in another preferred embodiment of the present invention, the alignment of the valve disk 131 could also be accomplished by introducing the openings 184, 186 within the arms 154 alone or in combination with openings 174, 176 of the central hub region 150 that align with alternatively located projections 192 on the input coupling assembly 11 and still fall within the spirit of the present invention.

Moreover, as best shown in FIGS. 11 and 12, the valve 131 in yet another preferred embodiment of the present invention could alternatively be formed with projections 192 along a bottom side 194 of the central hub region 150 or along a bottom side 194 of the valve arms 154 that extend within corresponding openings 196 in the input-coupling assembly 11 and accomplish the same kind of alignment.

The valve disk 131 of any of the preferred embodiments offers many improvements over the valve disk 31 of FIG. 6. First, a more precise geometry is easier to achieve over a smaller surface. Therefore, it is easier to manufacture the valve disk 131 to more exact size and roundness along its outer-arced surfaces 170, 172 and with more consistent flatness and perpendicularity on its face/end portions 176, 178 than it is to manufacture the valve disk 31 having the corresponding continuous outer-arced surface 158 and face/end surface 160. Thus, the outer-outer arced surfaces 170, 172 achieve tighter and more consistent clearance with the inner surface 162 to prevent sticking or leaks. Further, the face end portions 176, 178 generally seal better to the reservoir cover 59 than the face end portions 160 of the valve disks 31 of the prior art.

Second, the present invention minimizes sticking and leakage of the valve disk 131 associated with particle contamination.

Third, the removal of excess weight from the prior art valve disk and the minimizing of conditions that lead to sticking of the valve disk also have a positive effect on the magnetic control of the positioning of the valve disk 131. Less force is required to move a lighter valve or a non-sticking valve, and hence precision control of the positioning of the valve 131 is easier to achieve.

Further, the small arc sections 170, 172 result in less fluid drag (viscous shear) than the previous design.

The valve disk 131 of the present invention, in any of the preferred embodiments, may be formed of a wide variety of materials. Preferably, the valve disk 131 is formed of a thermosetting polymeric material that is capable of withstanding high operating temperatures commonly found in fluid coupling devices 10. In addition, the valve disk 131 must be chemically resistant to the viscous fluid contained in the fluid reservoir chamber 35. One such material is a thermosetting phenolic resin commonly known as bakelite. In addition, the valve disk 131 is preferably formed using conventional molding or processing techniques such as injection molding and the like.

While the invention has been described in connection with one embodiment, it will be understood that the invention is not limited to that embodiment. On the contrary, the invention covers all alternatives, modifications, and equivalents as may be included within the spirit and scope of the appended claims.

What is claimed is:

1. An electronically controlled viscous fan drive used on an internal combustion engine comprising:
an output-coupling member including a housing member coupled to a cover member;
an actuator shaft;
an input-coupling assembly coupled to said actuator shaft and including an input-coupling member, said input-coupling-assembly and said actuator shaft capable of rotating at a given input speed,
a fluid operating chamber defined by said input-coupling member and said cover member,
a pair of fill holes contained in said input coupling member fluidically coupling said fluid reservoir chamber to said fluid operating chamber;
a valve disk coupled to said actuator shaft and said input-coupling member and disposed between said input-coupling member and said reservoir cover, said valve disk comprising a plurality of radially balanced arms coupled between a central hub region and an outer cylinder region, said outer cylinder region including a first arc section and a second arc section separated by a pair of non-arced sections,
an actuator subassembly coupled to said input-coupling assembly and including an external controller electrically coupled to an electric coil, said electrical coil capable of being electrically activated by said external controller to generate a magnetic flux;
an armature coupled around a portion of said actuator shaft and within said actuator subassembly, said armature capable of axial movement along the length of said input-coupling assembly in response to said magnetic flux, therein moving said actuator shaft to position said valve disk relative to said at least one fill hole between an engaged position, a partially engaged position, or in a disengaged position;
wherein said engaged position is characterized such that said valve disk is positioned wherein said first arc section is uncovered from a first one of said pair of fill holes and said second arc section is uncovered from a second one of said pair of fill holes, therein allowing maximum flow of said viscous fluid from said fluid reservoir chamber to said fluid operating chamber to drive said output-coupling member at a maximum rotational speed at said given input speed;
wherein said disengaged position is characterized such that said valve disk is positioned wherein said first arc section covers said first one of said pair of fill holes and said second arc section covers said second one of said pair of fill holes to prevent flow of said amount of viscous fluid from said fluid reservoir chamber to said fluid operating chamber; and
wherein said partially engaged position is characterized such that said valve disk is positioned wherein said first arc section partially covers said first one of said pair of fill holes and said second arc section partially covers said second one of said pair of fill holes to allow a limited amount of said viscous fluid to flow from said fluid reservoir chamber to said fluid operating chamber to drive said output-coupling member at a rotational speed less than said maximum rotational speed.

2. The fan drive of claim 1, wherein said first arc section is disposed approximately 180-degrees radially relative to said second arc section along said outer cylinder region.

3. The fan drive of claim 2, wherein each of said pair of non-arced sections comprises approximately a 160-degree radial section of said outer cylinder region.

4. The fan drive of claim 1, wherein each of said pair of non-arced sections comprises approximately a 160-degree radial section of said outer cylinder region.

5. The fan drive of claim 1, wherein said disengaged position is further characterized wherein a face/end portion of said first arc section and a face/end portion of said second arc section are sealingly coupled to said reservoir cover.

6. The fan drive of claim 1, wherein said central hub region further comprises a plurality of openings and wherein said input-coupling assembly further comprises a plurality of projections, one of said plurality of projections being coupled within a corresponding one of said plurality of openings to align said valve disk such that said first arc section substantially seals to said first one of said pair of fill holes and said second arc section substantially seals with said second one of said pair of fill holes when the fan drive is in said disengaged position.

7. The fan drive of claim 1, wherein each of said plurality of radially balanced arms includes an opening and wherein said input-coupling assembly further comprises a plurality of projections, one of said plurality of projections being coupled within a corresponding one of said openings to align said valve disk such that said first arc section substantially seals to said first one of said pair of fill holes and said second arc section substantially seals with said second one of said pair of fill holes when the fan drive is in said disengaged position.

8. The fan drive of claim 1, wherein said central hub region further comprises a plurality of projections and wherein said input-coupling assembly further comprises a plurality of openings, one of said plurality of projections being coupled within a corresponding one of said plurality of openings to align said valve disk such that said first arc section substantially seals to said first one of said pair of fill holes and said second arc section substantially seals with said second one of said pair of fill holes when the fan drive is in said disengaged position

9. A valve disk comprising:
a central hub region having a central opening;
a plurality of radially balanced arms coupled to said central hub region; and
an outer cylinder region including a first arc section and a second arc section separated by a pair of non-arced sections.

10. The valve disk of claim 9, wherein said central hub region includes a plurality of openings disposed outwardly of said central opening.

11. The valve disk of claim 9, wherein said first arc section comprises a continuous arc outer surface and a face/end surface, said face/end surface being substantially perpendicular to said continuous arc outer surface.

12. The valve disk of claim 11, wherein said second arc section comprises a continuous arc outer surface and a face/end surface, said face/end surface being perpendicular to said continuous arc outer surface.

13. The valve disk of claim 9, wherein said first arc section is disposed approximately 180-degrees radially relative to said second arc section along said outer cylinder region.

14. The valve disk of claim 9, wherein said a plurality of radially balanced arms comprises a pair of radially balanced arms.

15. The valve disk of claim 9, wherein said a plurality of radially balanced arms comprises at least three radially balanced arms.

16. The valve disk of claim 9, wherein each of said plurality of radially balanced arms includes an opening.

17. The valve disk of claim 9, wherein said central hub region includes a plurality of projections formed thereon.

18. An improved valve disk for use in an electronically controlled viscous coupling system having an input coupling assembly and an output coupling assembly, the valve disk controlling the flow of viscous fluid from a fluid reservoir chamber to a fluid operating chamber through a pair of fill holes to control the engagement of the output coupling assembly, the improvement comprising removing a pair of arced sections of a cylinder region of the valve disk not corresponding to said pair of fill holes, therein leaving a first arc section corresponding to a first one of said pair of fill holes and a second arc section corresponding to a second one of said pair of fill holes.

19. The electronically controlled viscous coupling of claim 18 wherein said valve disk includes a plurality of openings corresponding to an equal number of projections within said input coupling assembly, one of said plurality of projections coupled within one of said plurality of openings to align said first arc section to seal over said first one of said pair of fill holes and to align said second arc section over said second one of said pair of fill holes when the viscous coupling system is in a disengaged position, said disengaged position preventing the flow of viscous fluid from the fluid reservoir chamber to the fluid operating chamber and therein preventing engagement of the output coupling assembly.

20. The electronically controlled viscous coupling of claim 18 wherein said valve disk includes a plurality of projections corresponding to an equal number of openings within said input coupling assembly, one of said plurality of projections coupled within one of said plurality of openings to align said first arc section to seal over said first one of said pair of fill holes and to align said second arc section over said second one of said pair of fill holes when the viscous coupling system is in a disengaged position, said disengaged position preventing the flow of viscous fluid from the fluid reservoir chamber to the fluid operating chamber and therein preventing engagement of the output coupling assembly.
